(19) United States
(12) Patent Application Publication
(10) Pub. No.: US 2006/0091294 A1
(43) Pub. Date: May 4, 2006

(54) Apparatus and method for interference suppression in optical or radiation sensors

(76) Inventors: Michael Frank, Erlangen (DE); Ulrich Schatzle, Strullendorf (DE)

Correspondence Address: SCHIFF HARDIN LLP;Patent Department, 6600 Sears Tower, 233 South Wacker Drive, Chicago, IL, 60606, US

(21) Appl. No.: 10/976,471

(22) Filed: Oct. 29, 2004

(51) Int. Cl. G01J 1/44

(52) U.S. Cl. 250/214 B; 398/39; 340/870.29

(57) ABSTRACT

An apparatus and appertaining method is provided for systems having an illumination transmitter and an illumination receiver in which the illumination receiver receives radiation emitted by the illumination transmitter but also receives ambient radiation that adds unwanted noise to the signal received by the receiver. Advantageously, the illumination transmitter transmits a pulsed signal having an on state and an off state. An on state sample and hold circuit samples the signal when the receiver is receiving both the transmitter signal and ambient radiation, and an off state sample and hold circuit samples the signal when the receiver is only receiving the ambient radiation. The off state signal is subtracted from the on state signal, thereby providing an output that is free of the ambient radiation signal.

### BACKGROUND

The present invention relates to optical or radiation devices that use an illumination device and a light or radiation receiver that is subject to noise in the form of extraneous light or radiation from the environment. In such devices, a problem exists in that such noise introduces spurious signals in the coupling between the light transmitter and the light receiver resulting in an erroneous output from the receiver.

In order to minimize the effect of extraneous light reaching the light receiver, various known approaches have been implemented. One solution has been to simply provide a shade that blocks incidental extraneous light from entering the light receiver, thereby increasing the signal to noise ratio. However, a shade can be impractical in certain situations or may only be partially effective, and can lead to malfunctions in the device.

Another solution has been to increase the amount of illumination provided by the illumination device/transmitter which also reduces the signal to noise ratio for a given amount of extraneous light. This is disadvantageous in that it increases the power requirements by both the transmitter and the receiver in that, among other things it increases the current requirements of the sensor and is thus possible only in a limited manner with battery-fed sensors.

A further solution has been to provide filters that block the frequency range of an interfering source. Such filters, however, only work well when the nature of the interference is well known. When the usable signal additionally possesses signal portions in the frequency range of the interference source, the barrier filter also distorts the usable signal.

Various types of extraneous light interference include a frequency cycle associated with a main power supply when room lighting utilizes alternating current, e.g., 50 Hz according to the European standard and 60 Hz according to the U.S. standard, as well as an interference from a constant light superimposition such as sunshine.

Typical optical sensors include pulse sensors and oxygen saturation sensors, light barriers and distance detectors, and smoke sensors and gas analysis sensors.

### SUMMARY

A solution to the previously described problems is achieved by an apparatus for suppressing an interference signal in an electromagnetic radiation sensor comprising: an transducer having an electromagnetic radiation input and a signal output configured to provide a signal that is related to an electromagnetic radiation strength at the input, wherein the radiation strength at the input comprises radiation produced from a pulsed signal of a radiation transmitter and ambient radiation; a dark sample and hold circuit connected to the signal output of the transducer and configured to sample the output signal of the transducer during a time period when the pulsed signal of the radiation transmitter is in a non-emitting off state, the dark sample and hold circuit comprising an output; a light sample and hold circuit connected to the signal output of the transducer and configured to sample the output signal of the transducer during a time period when the pulsed signal of the radiation transmitter is in an emitting on state, the light sample and hold circuit comprising an output; a difference amplifier comprising a first input connected to the output of the dark sample and hold circuit, a second input connected to the output of the light sample and hold circuit, and an output configured to provide a difference between a signal received at the first input and a signal received at the second input, the output thereby producing a signal representative of the radiation produced by the radiation transmitter without the ambient radiation.

A solution is further achieved by a method is provided for suppressing an interference signal in an electromagnetic radiation sensor comprising: producing a transmitted pulsed electromagnetic radiation signal by a radiation transmitter using a transmitter switch, the transmitted signal having a periodic on state and off state; receiving the pulsed electromagnetic radiation signal and ambient electromagnetic radiation by a transducer and producing a transducer output signal in response; during the off state of the transmitted signal, sampling the transducer output signal by a dark sample and hold circuit, thereby producing a dark-based signal which is an off state signal related to the ambient electromagnetic radiation received by the transducer; during the on state of the transmitted signal, sampling the transducer output signal by a light sample and hold circuit, thereby producing a light-based signal which is an on state signal related to the on state transmitted electromagnetic radiation signal combined with the ambient electromagnetic radiation received by the transducer; and subtracting the dark-based signal from the light-based signal, thereby providing an output related to the on state transmitted electromagnetic radiation signal without an ambient electromagnetic signal related to the off state signal.

The invention can be used in a wide variety of applications. An exemplary application is illustrated in FIG. 1 which was taken from U.S. Pat. No. 6,711,434, herein incorporated by reference. In this Figure, a finger ring sensor 21 is provided that transmits a signal corresponding to a pulse measurement of a subject over a light wave conductor 22 (e.g., fiber optic cable). In this exemplary system, a light transmitter is configured as an LED and is conducted to the finger ring sensor 21 of the subject via the light wave conductor 22, and the received light is conducted from the finger ring sensor 21 to a photodiode via the light wave conductor 22.

### DESCRIPTION OF THE DRAWINGS

An embodiment of the invention is further described below with respect to the drawing figures.

FIG. 1 is a schematic block diagram illustrating a known use to which the present invention may be applied;

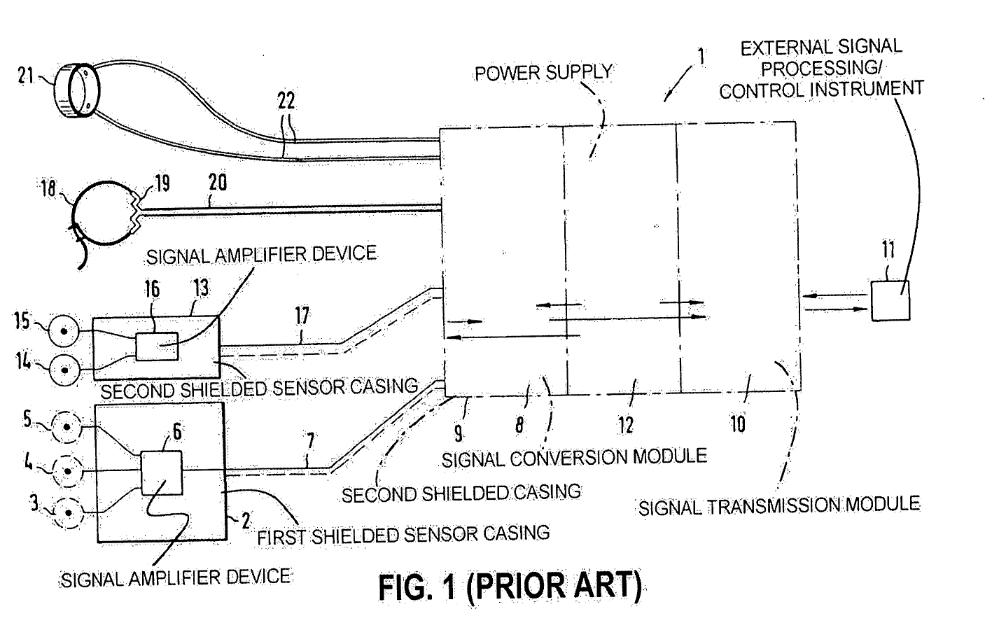

FIG. 2 is a schematic circuit diagram according to an embodiment of the invention; and

FIGS. 3A & B are exemplary timing diagrams.

### DETAILED DESCRIPTION OF THE PREFERRED EMBODIMENTS

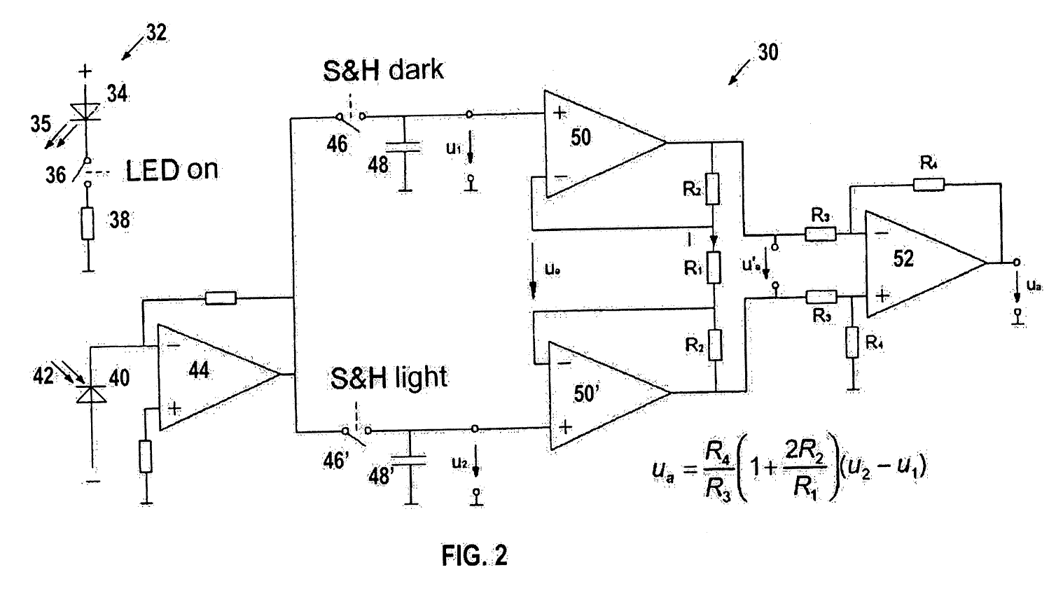

As used herein, the term “light” is intended to encompass all forms of electromagnetic radiation in frequencies that have transmission and detection properties similar to light. Furthermore, the terms “optical transmitter”, “optical receiver” are intended to refer to electromagnetic radiation transmitters and receivers for similar such frequencies. According to the embodiment shown FIG. 2, a pulsed illumination device 32 comprises a light-emitting diode (LED) 34 connected on one side to a power supply and on another side in series with a transmitter switch 36 and through a current limiting resistor 38 to ground. A light pulse 35 is emitted when the transmitter switch 36 is closed and then opened.

On the receiver side, a light receiver (light to voltage converter) 40, e.g., a photodiode or phototransistor, receives the incoming light pulse 42 and converts it into a pulsed electrical signal which may be amplified by a pre-amplifier 44. During a dark time period before the light pulse 42 has been received, a sample and hold-dark circuit 46 with a possible high frequency filter 48, e.g., capacitor, samples the input signal during this dark period, and the dark sampled signal u₁ is conditioned by a further amplifier 50. This signal represents ambient light that is not originating from the pulsed illumination device 32 and would normally constitute noise. The output of the further amplifier 50 is connected to, e.g., a negative input of a difference amplifier 52, with appertaining biasing and feedback circuitry.

Similarly, during a light time period, after the light pulse 42 has been received and any appertaining delays required for the converted electrical signal to stabilize at the output of the pre-amplifier 44, a sample and hold-light circuit 46′ with a possible high frequency filter 48′, e.g., capacitor, samples the input signal during this light period, and the light sampled signal u₂ is conditioned by a corresponding further amplifier 50′. This signal represents a sum of the desired pulsed light 35 plus the ambient light present at the light receiver 40. The output of this further amplifier 50′ is connected, e.g., to a positive input of the difference amplifier 52, with appertaining biasing and feedback circuitry.

The sample and hold circuitry 46, 46′ is synchronized with the transmitter switch 36 used for pulsing the illumination source (which may incorporate relevant circuit delays, settling times, etc.). This may be performed by using known techniques for synchronization. Using the timing guidelines discussed below, only one sample in the on state and one sample in the off state per period of the transmitter should be required to provide accurate results—however, it is also possible that multiple samples can be taken in either or both of the on-state and off-state per period of the transmtter.

The sampled signal during the dark period comprising the interfering light is thus subtracted from the sampled signal during the light period comprising the desired pulsed light plus the interfering light, thereby producing a signal in which the interfering light portion has been removed at an output of the difference amplifier 52.

This system functions well as long as the interfering light signal does not significantly change during both samplings; in order to reduce this risk, the temporal separation of both the transmitted pulses as well as the sampling interval Δt should be selected optimally short with respect to the frequency of the interfering signal f_{interference}. As a guideline from practice the time period should be:
Δt<1/(10×f_{interference}).

As to the pulse frequency from the light source 34, as dictated by the Nyquist sampling theorem, the pulse repetition rate is selected higher by at least a factor of 2 than the highest usable signal frequency. As a guideline from practice, the pulse frequency should be:
fₚᵤₗₛₑ=10×f_{usuable}.

The pulse duration tₚᵤₗₛₑ is at least the rise time tᵣᵢₛₑ of the light receiver 40 with photointensifer/preamplifier 44 plus the sampling time t_{S&H} of the sample and hold stage 46, 46′.

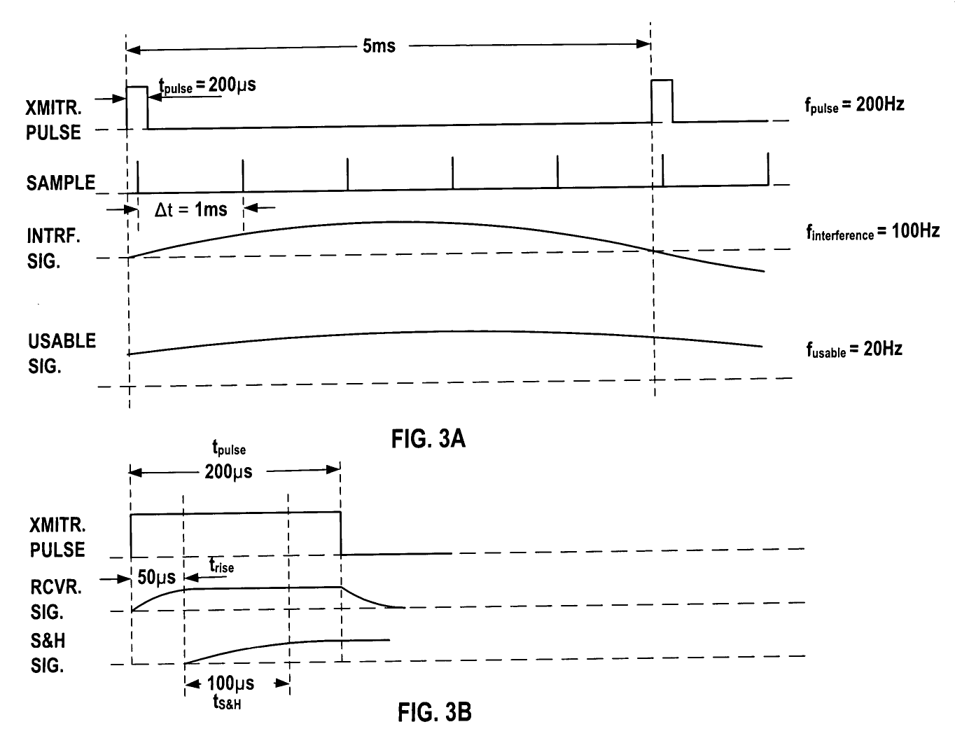

In a practical application where an optical pulse sensor such as is used to trigger cardiological MR sequences, these values could be provided as follows and as illustrated in FIGS. 3A and 3B:
separation of samples dark/light: Δt=1 ms (according to criterion, and as illustrated in FIG. 3A) or as low as 200 μs (pulse duration) or lower
highest interference signal frequency: f_{interference}=100 Hz (10 ms period)
pulse repetition rate: fₚᵤₗₛₑ=200/s (5 ms period)
highest usable signal frequency: f_{usable}=20 Hz
transmitter pulse duration: tₚᵤₗₛₑ=200 μs
rise time of the light receiver: tᵣᵢₛₑ=50 μs
sample time for sample and hold: t_{S&H}=100 μs

Since the light from the illuminating device 32 is applied in a pulsed manner, the averaged power requirement of the sensor remains low. Or, conversely, in order to increase the sensitivity of the device, the pulse capacity can be increased in battery-operated sensors. In the numerical example described above, the ratio of average capacity to pulse capacity can be determined as:
P_{average}/Pₚᵤₗₛₑ=tₚᵤₗₛₑ×fₚᵤₗₛₑ=200 μs×200 Hz=4%.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional electronics and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. An apparatus for suppressing an interference signal in an electromagnetic radiation sensor comprising:
an transducer having an electromagnetic radiation input and a signal output configured to provide a signal that is related to an electromagnetic radiation strength at the input, wherein the radiation strength at the input comprises radiation produced from a pulsed signal of a radiation transmitter and ambient radiation;
a dark sample and hold circuit connected to the signal output of the transducer and configured to sample the output signal of the transducer during a time period when the pulsed signal of the radiation transmitter is in a non-emitting off state, the dark sample and hold circuit comprising an output;
a light sample and hold circuit connected to the signal output of the transducer and configured to sample the output signal of the transducer during a time period when the pulsed signal of the radiation transmitter is in an emitting on state, the light sample and hold circuit comprising an output;
a difference amplifier comprising a first input connected to the output of the dark sample and hold circuit, a second input connected to the output of the light sample and hold circuit, and an output configured to provide a difference between a signal received at the first input and a signal received at the second input, the output thereby producing a signal representative of the radiation produced by the radiation transmitter without the ambient radiation.

2. The apparatus according to claim 1, further comprising:
a preamplifier connected between the output of the transducer and the inputs of both the dark sample and hold circuit and the light sample and hold circuit.

3. The apparatus according to claim 1, further comprising:
a first amplifier stage having a first input connected to the output of the dark sample and hold circuit and the first input of the difference amplifier; and
a second amplifier stage having a first input connected to the output of the light sample and hold stage and the second input of the difference amplifier.

4. The apparatus according to claim 3, further comprising:
a first resistor connected to the output of the first amplifier stage and a second input of the first amplifier stage;
a second resistor connected to the output of the second amplifier stage and a second input of the second amplifier stage, having a same resistance value as the first resistor;
a third resistor connected between the first and second resistor;
a fourth resistor connected between the output of the first amplifier stage and the first input of the differential amplifier;
a fifth resistor connected between the output of the second amplifier stage and the second input of the differential amplifier, having a same resistance value as the fourth resistor;
a sixth resistor connected between the first input of the differential amplifier and the output of the differential amplifier; and
a seventh resistor connected between the second input of the differential amplifier and a ground, having a same resistance value as the sixth resistor.

5. The apparatus according to claim 1, wherein the transducer is a photodiode or phototransistor.

6. The apparatus according to claim 1, wherein the transducer is an optical transducer and the electromagnetic radiation is radiation in the visible light spectrum.

7. A method for suppressing an interference signal in an electromagnetic radiation sensor comprising:
producing a transmitted pulsed electromagnetic radiation signal by a radiation transmitter using a transmitter switch, the transmitted signal having a periodic on state and off state;
receiving the pulsed electromagnetic radiation signal and ambient electromagnetic radiation by a transducer and producing a transducer output signal in response;
during the off state of the transmitted signal, sampling the transducer output signal by a dark sample and hold circuit, thereby producing a dark-based signal which is an off state signal related to the ambient electromagnetic radiation received by the transducer;
during the on state of the transmitted signal, sampling the transducer output signal by a light sample and hold circuit, thereby producing a light-based signal which is an on state signal related to the on state transmitted electromagnetic radiation signal combined with the ambient electromagnetic radiation received by the transducer; and
subtracting the dark-based signal from the light-based signal, thereby providing an output related to the on state transmitted electromagnetic radiation signal without an ambient electromagnetic signal related to the off state signal.

8. The method according to claim 7, further comprising:
amplifying the transducer output signal prior to sampling the transducer output signal with a preamplifier.

9. The method according to claim 7, further comprising:
amplifying the light-based signal by a first amplifier stage; and
amplifying the dark-based signal by a second amplifier stage;
wherein the amplifying of both the light-based signal and the dark-based signal occurs before the subtraction.

10. The method according to claim 7, further comprising:
synchronizing the sampling of the light sample and hold circuit and the sampling of the dark sample and hold circuit with the periodic switching of the transmitter switch.

11. The method according to claim 10, further comprising:
determining a maximum frequency of the ambient electromagnetic radiation; and
switching the transmitter switch through the on state and the off state at a frequency at least ten times the frequency of the ambient electromagnetic radiation.

12. The method according to claim 10, further comprising:
determining a maximum frequency of a useable signal to be detected; and
switching the transmitter switch through the on state and the off state at a frequency at least ten times the useable frequency.

13. The method according to claim 7, further comprising:
minimizing a duty cycle of the transmitted signal so it is just greater than a sum of a rise time of the transducer and a sampling time of a sample and hold stage used for the sampling.

14. The method according to claim 7, further comprising:
detecting a pulse of a subject with the electromagnetic radiation sensor.

15. The method according to claim 14, wherein the transmitted signal has a period of 5 ms and a pulse duration of 200 μs.
